(19) United States
(12) Patent Application Publication
(10) Pub. No.: US 2017/0166315 A1
(43) Pub. Date: Jun. 15, 2017

(54) VERTICAL TAKE-OFF AND LANDING AIRCRAFT

(71) Applicant: Gevorg Serezhaevich NOROIAN, Prinorskij kray (RU)

(72) Inventor: Gevorg Serezhaevich NOROIAN, Primorskij kray (RU)

(21) Appl. No.: 15/323,757

(22) PCT Filed: Aug. 14, 2015
(86) PCT No.: PCT/RU2015/000520

§ 371 Date: Jan. 4, 2017

(30) Foreign Application Priority Data
Jul. 8, 2014 (RU) 2014127730

(51) Int. Cl. B64D 27/20; B64C 15/02; B64C 25/00; F04D 19/02; F01D 5/02; F01D 5/12; F01D 7/00; B64C 39/00; F02K 7/00

(52) U.S. Cl. CPC B64D 27/20; B64C 39/001; B64C 15/02; B64C 25/00; F02K 7/00; F01D 5/02; F01D 5/12; F01D 7/00; F04D 19/02; B64D 2221/00; F05D 2220/90

(57) ABSTRACT

A vertical take-off and landing aircraft comprising two turbines, the lower of which is plate-like, and the upper is flat or plate-like. Each turbine comprises a reactive power plant comprising an air engine and receivers connected to a compressor. The body of each turbine is mounted on a metallic disc connected to a vertical shaft of the aircraft, and is equipped with vanes. The vanes are mounted in a single row along the perimeter of the body or are arranged in a single tier such that the position thereof can be changed. The aircraft can comprise intermediate turbines which are mounted between the upper and lower turbine and are flat or plate-like. The body of each turbine is metallic and comprises two rings, one of which is connected to the disc, and also radial struts mounted along the perimeter of the turbine body and connected to the rings and vanes.

The invention relates to aviation technology, specifically to vertical take-off and landing aircraft, and can be used in civil and military aviation, as well as space technology.

The closest in technical essence to the claimed aircraft is the vertical take-off and landing aircraft (RU 2266846 C2, B64C29/02, B64C21/04, published on 27 Dec. 2005). This aircraft comprises a jet propulsion power unit positioned in the center of a flat circular wing that comprises turbo compressors. The lift of the specified aircraft is formed by the difference between the static pressure of the air acting on the bottom of the aircraft and static pressure of the circular radiating air jet acting on the top of the aircraft.

The disadvantages of this aircraft are the inability to provide sufficient lift and weight efficiency, including high consumption of fuel spent on release of the static pressure on the top, which reduces cost effectiveness and reliability of the aircraft.

The technical result of the present invention is to provide a cost-efficient and reliable aircraft capable of moving vertically, horizontally or with any inclination using air streams.

The specified technical result is achieved in that the vertical take-off and landing aircraft comprises at least two turbines, the lower of which is of plate-like shape, and the upper is of flat or plate-like shape, each turbine comprising a jet propulsion power unit and the casing of each turbine is mounted on a metallic disk connected to a vertical shaft of the aircraft, and is equipped with blades mounted in such way that the position thereof can be changed.

The aircraft may comprise at least one intermediate turbine mounted between the upper and lower turbines and made flat or plate-like.

The aircraft may be equipped with a cockpit.

The jet propulsion power unit of each turbine comprises at least one air engine and receivers connected to a compressor or compressors.

To provide lateral motion, the aircraft is equipped with at least one horizontal motion turbine and air intakes connected to the bypass control valves by means of the internal turbine receivers.

The casing of each turbine is metallic and comprises at least two rings, one of which is connected to the disk, and also radial struts mounted along the perimeter of the turbine casing and connected to the rings and blades.

To change the position of the blades, the aircraft is equipped with a blade pitch control device and/or blade extension control device.

The blades may be mounted:
at least in one row along the perimeter of the casing;
at least in one tier;
with partial overlapping.

The aircraft comprises additional side blades mounted on the casing of the turbines and configured to change the rotation angle by up to 90°.

The aircraft comprises electric generators.

To ensure the horizontal position in the air, the aircraft may be equipped with a balancing wing with adjustable position mounted on the casing of the upper turbine.

The aircraft may be equipped with supports for the purpose of the aircraft landing and parking.

Presence of the turbines in the aircraft, which use headwind force whilst landing and moving in any direction, allows breaking upper atmospheric drag due to air passing through the turbines from top to bottom helping the aircraft get off, put on high speed (both when climbing and moving), and save energy when moving.

The aircraft comprises at least two turbines—the lower one and the upper one. Depending on the aircraft load lifting capacity it may comprise at least one intermediate turbine. The lower turbine has a plate-like shape and the intermediate turbines may have either plate-like or flat shape. The intermediate turbine or several intermediate turbines are mounted between the upper and the lower turbines. Each turbine is installed horizontally on a respective disk connected to the aircraft vertical shaft.

The casing of each turbine (upper, lower and intermediate) is metallic provided with at least two rings (small and large), one of which (the larger one) is mechanically fastened on the respective disk, as well as radial struts (supports beams) installed inclined and connected to the rings. The casing of the turbines may comprise one or several intermediate rings mounted between the small and the large rings. The number of the intermediate rings depends on the aircraft size (the bigger the aircraft is, the more intermediate rings may be mounted) and blade sizes.

All rings (including intermediate) of the casing of the turbines are mechanically fastened to each other by the radial struts.

The radial struts (support beams) may be installed horizontally (flat turbine) or vertically inclined (plate-like turbine). The struts may be produced straight or arc-shaped (for spherical aircraft). The number of the struts is chosen based on the number and size of the blades.

The radial struts and casing rings of the turbines may have either round profile (pipe-shaped) or other profile.

The radial struts of the turbines casing may be also used as extra receivers in case of emergency landing of the aircraft.

A structure in the form of a truss may be used as the turbine casing where necessary.

The blades are mounted along the entire perimeter of the casing of each turbine; they are fastened to the supporting axles (radial struts) and adapted to side rotation on the axle (to the right and left). The blade may be fastened to the strut at any point—either at the center of the blade or on the edge.

The blades may be mounted at least in one row along the entire perimeter of the turbine casing. The row of the blades is positioned between two rings of the turbine casing. One intermediate ring is added for each successive row of blades in the turbine casing. Diameters of the intermediate rings depend on the blade length in the added row and the size of the aircraft turbine casing.

The blades may be mounted in different ways: adjacent to each other, partially overlapping or with a gap between each other.

The blades are made of metal. The number of blades and their width may vary and depends on the aircraft size. It is preferable to make the blades flat or trapezium-shaped.

The blades may be also positioned at least in one tier. The number of tiers is chosen based on the required power of the aircraft. Moreover, the second and following tiers of the blades are fastened under the upper tier (row) of the blades. The size of the blades on the second and following tiers may be either equal to the size of the upper blades or different. In each case, the size of the blades should be separately calculated. The blades of the second and following tiers may be mounted in parallel of with a slight incline towards the upper tier of the blades. The distance between the blade tiers may vary.

There are blade pitch control and/or blade extension control devices provided for the blades, which are installed on the shaft and enable controlling the blade operation—side tilt of the blade and vertical extension of the blade (lifting or lowering), i.e. changing the blade position. In addition the blade is connected to the blade pitch control device by means of the adjusting lever. The blade is connected to the blade extension control device by means of the adjusting lever and rod, one end of which is fastened to one of the casing rings (the smaller one) by hinge supports, and the other—to the respective blade. The rods are installed in parallel with the radial struts and evenly spaced across the entire radius of each casing of the turbines.

The tilt and extension control devices of the blades provide for autonomous and synchronous operation of each row (or tier) of the aircraft blades.

The rods, to which the blades are connected, are hinged to the (smaller) ring of the turbines casing.

The aircraft may additionally have side (vertical) blades mounted on the casing of the turbines (on the edges) and adapted to change the rotation angle by up to 90°. The motion of the side blade is ensured by the side blade tilt control device and/or side blade extension control device mounted on the shaft and enabling controlling over the side blade operation. The side blades are connected to the control devices in the same way as the other turbine blades. In case of horizontal movement, one side of the side blade tilts for air entrainment, and during landing there is an additional extension (lifting) of the side blade. The angle of the side blade rotation is adjusted in accordance with required speed of landing or climbing of the aircraft. The side blades may have a square shape and may be mounted on ball joints. The rods, to which the side blades are connected, are hinged to the (larger) ring of the turbines casing.

The intermediate turbines may be fabricated with a smaller diameter and installed in the upper or lower turbines so that they are invisible from outside. In such cases, the intermediate turbines are designed without the side blades.

The upper turbine may have the form of an overturned plate. The lower turbine is plate-shaped, i.e. it looks like a plate reversed upside-down. The lower turbine is designed in the same manner as the upper turbine. The radial struts on the upper turbine and lower turbine may be installed at an identical angle or at different angles to the plane of the horizontal disks.

Each of the turbines is connected to the jet propulsion power units (JPPU). The number and power of JPPU's depends on the number of the aircraft turbines. The JPPU of each turbine includes at least one air engine and receivers connected to the compressor or compressors. All JPPU's operate synchronously during take-off (with the same rpm number) even in case of using JPPU's of different power. Each JPPU is also provided with an integrated starter generator. The JPPU nozzles are directed downwards for aircraft lift augmentation. The JPPU air engine is connected to the receiver and operates in case of emergency to provide for the safe landing of the aircraft.

To ensure the lateral-direction motion (in the horizontal plane), the aircraft may be equipped with at least one horizontal motion turbine and air intakes connected to the bypass control valves by means of horizontal motion turbine receivers. The horizontal motion turbines may be installed horizontally between the upper and the intermediate turbines or between the lower and the intermediate turbines, or between the intermediate turbines. The number of the horizontal motion turbines may vary. At the same time several synchronously operating internal turbines (at least two) of equal capacity may be installed in each horizontal plane, e.g. one to the right of the aircraft cockpit, and the other to the left of the cockpit.

The horizontal motion turbines ensure forward motion and turning of the aircraft by means of increase or decrease in air passability of the JPPU nozzle.

The JPPU nozzles may be interconnected and equipped with the bypass valves to control exhaust gas passability of the nozzles. To improve the aircraft manoeuvrability, a separate compressor may be installed with a separate receiver and two or four separate outlets to different directions such that the bypass valves are open in case of the aircraft turning.

The aircraft is designed so that the center of gravity is lower (in terms of height) than the aircraft center. The main load is positioned in the central part of the aircraft slightly below (in terms of height) from the center so that to provide the aircraft stability.

To save fuel, the aircraft is equipped with electric generators. When required, the turbines switch to the electric generators and produce electricity that is distributed to the corresponding systems of the aircraft, including the blade tilt and extension control devices. The generated electricity may be used for any turbine of the aircraft if required.

The aircraft may be equipped with a control cockpit. The cockpit may be positioned in the center of the aircraft at the level of the horizontal motion turbines or above the upper turbine.

To provide for the landing and parking of the aircraft, it may be equipped with the supports (e.g. parking chassis) fastened to the casing of the lower turbine by various known means.

There may be several other design variants of the aircraft.

The aircraft may be designed without intermediate turbines. In this case the aircraft will comprise two turbines (upper and lower). Horizontal motion turbines may be also installed between the upper and lower turbines; in this case the center of gravity of the aircraft should be in the center of the lower turbine.

There is also an option to design the aircraft with a flat upper turbine and dish-shaped lower turbine. In this case, the aircraft may be also equipped with the horizontal motion turbines, and the center of gravity of the aircraft should be in the center of the lower turbine.

Specified altitude when the aircraft is moving is provided by the lower turbine due to its tapering.

To enhance stability, the aircraft may comprise a balancing wing installed horizontally on the upper turbine casing so that it does not interfere with the lifting of the blades. The balancing wing is fastened to the aircraft vertical shaft and fixed on the upper turbine casing by means of the ball joints. The height of the balancing wing is adjustable—when one part (upstream) of the aircraft is lifted, the other part (downstream) is lowered ensuring the required angle of air entrainment. When lifted to the vertical level, the balancing wing acts as a brake. When moving downwards the air acts on the top of the front end of the balancing wing, and the aircraft is moving upwards at an angle.

The aircraft balance may be also adjusted if the nozzle is directed downwards and an adjusting device is mounted on it to adjust the nozzle horizontal inclination.

The claimed invention is explained in the following drawings.

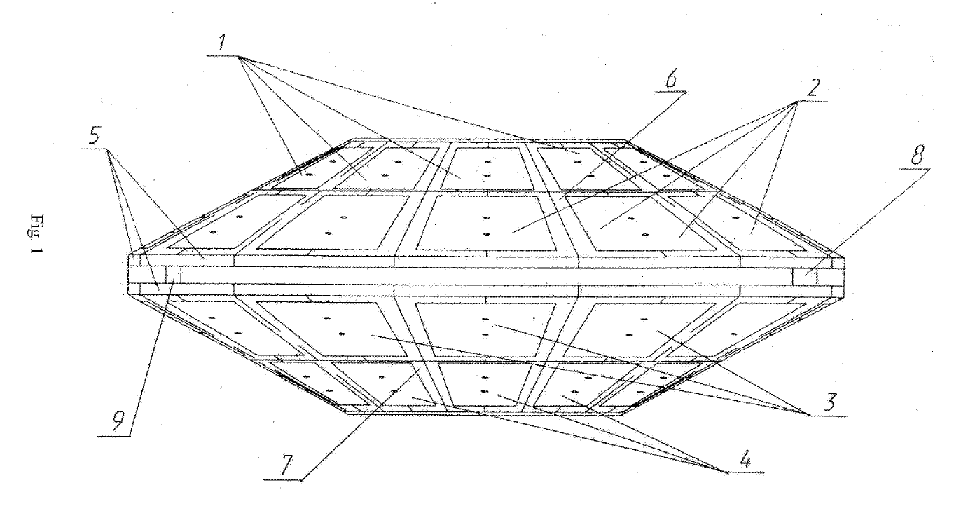

FIG. 1 shows the general view of the aircraft with the horizontal moving turbine;

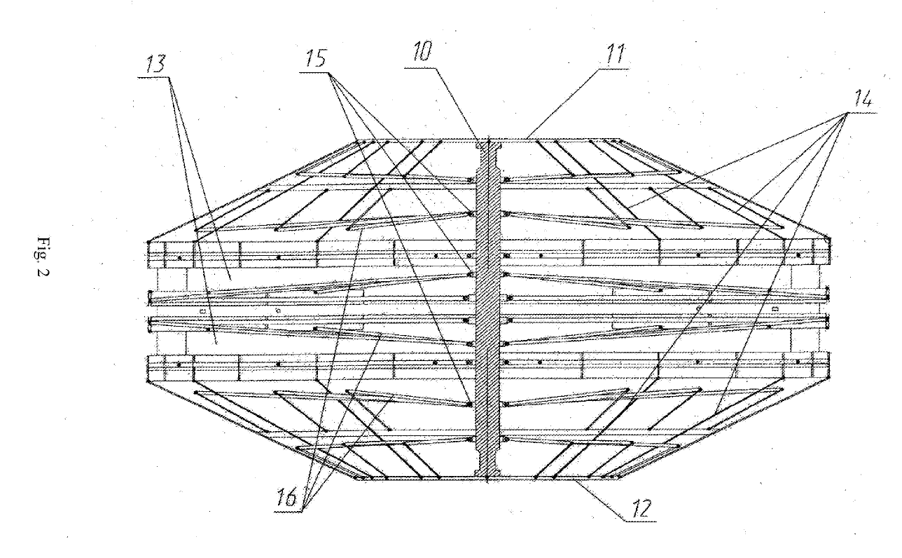

FIG. 2 shows the cross-sectional view of the aircraft with two intermediate turbines;

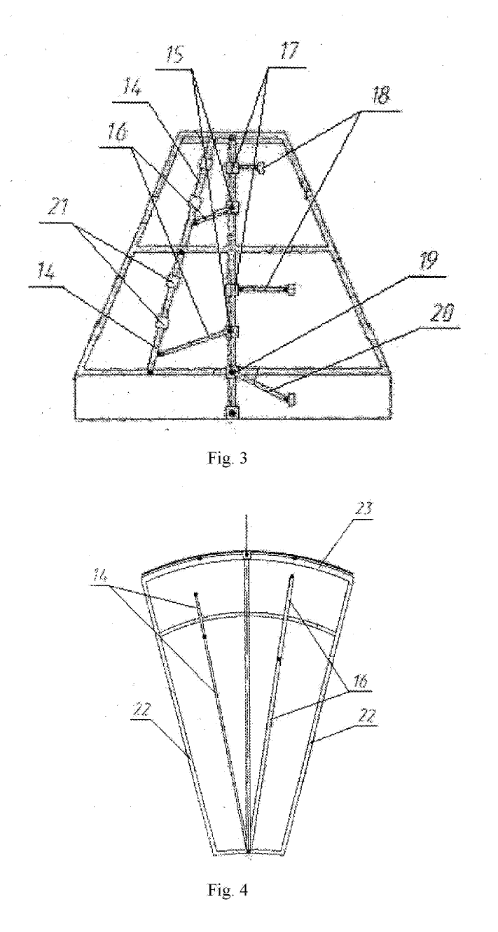

FIG. 3 shows the blades from two adjacent rows (inside view);

FIG. 4 shows a segment of the turbine casing with two adjacent rows of the blades (top view);

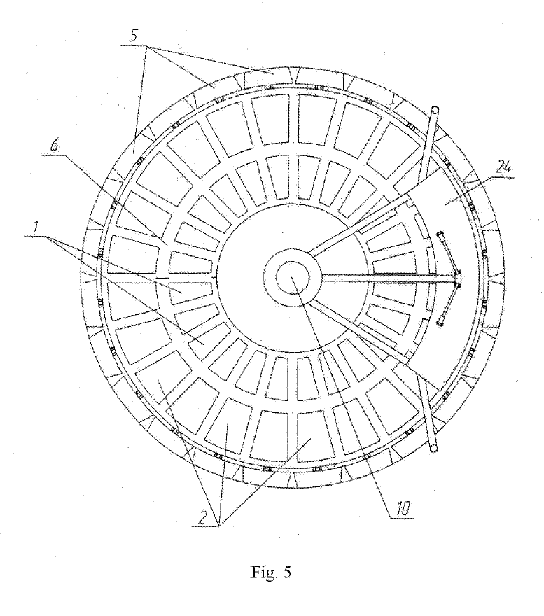

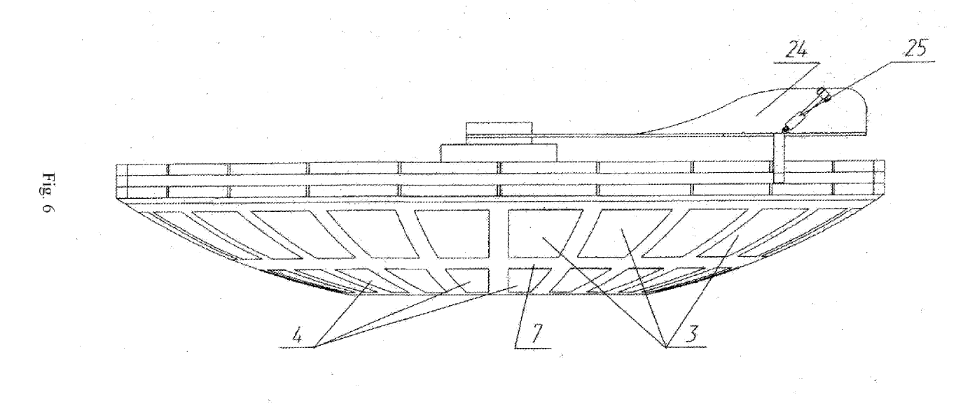

FIG. 5 shows the aircraft (top view);

FIG. 6 shows a design variant of the aircraft with upper flat turbine;

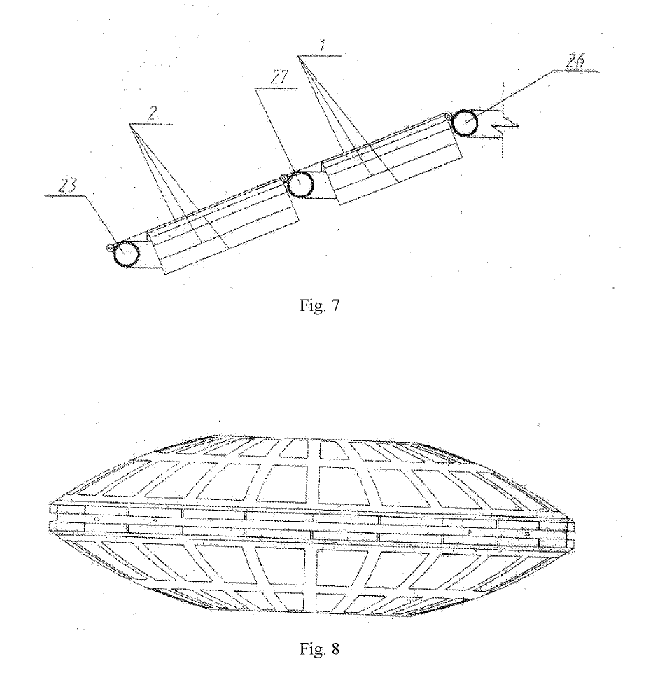

FIG. 7 shows connection of the blades mounted in the tier.

The aircraft components on the figures stated above are specified under the following reference numbers:

1—blade of one row of the upper turbine;

2—blade of the other row of the upper turbine;

3—blade of one row of the lower turbine;

4—blade of the other row of the lower turbine;

5—side blade;

6—casing of the upper turbine;

7—casing of the lower turbine;

8—nozzle of the jet propulsion power unit;

9—air intake of the horizontal motion turbine;

10—vertical axis of the aircraft;

11—small (upper) disk of the upper turbine;

12—small (lower) disk of the lower turbine;

13—intermediate turbine;

14—rod;

15—blade extension control device;

16—lever of the blade extension control device;

17—blade pitch control device;

18—lever of the blade extension control device;

19—side blade control device;

20—lever of the blade pitch control device;

21—ball joint;

22—radial strut;

23—larger ring of the casing;

24—balancing wing;

25—ball joint of the balancing wing;

26—smaller ring of the casing;

27—intermediate ring of the casing.

The claimed vertical take-off and landing aircraft operates as follows.

Air engines of the jet propulsion power units of the aircraft are started. During climbing, the blades 1, 2 of the upper turbine, blades 3, 4 of the lower turbine and side blades 5 of the upper and lower turbines are simultaneously open. The blade tilt control device 17 lifts (inclines) one side of the blades 1, 2 of the upper turbine and blades 3, 4 of the lower turbine by means of the levers 18; the other side of the blades 1, 2 of the upper turbine, blades 3, 4 of the lower turbine moves down automatically so that the air is boosted from the top and directed downwards (inside the aircraft casing). The blade extension control devices 15 lift the rods 14 by means of the levers 16 to extend the blades 1, 2 of the upper turbine and blades 3, 4 of the lower turbine to the required height. The side blade tilt control devices 19 by means of the levers 20 and side blade extension control devices (not shown in the drawings) control the change of the position of the side blades 5 so that the side blades 5 boost the air from the top and direct it downwards.

If the intermediate turbines 13 are available, the blades of the intermediate turbines 13 are open in climbing, and boost the air from the top and direct it downwards. The upper turbine sucks the air from the top and directs it downwards to the intermediate turbines 13; the latter in their turn direct the air to the lower turbine, which sends the air downwards. The air is exhausted (as exhaust gas) through the vertical RPU (not shown in the drawings) augmenting the aircraft lift. Thanks to the synchronous operation of all turbines, the aircraft easily takes off. After the aircraft has gotten off the ground, the turbines for lateral motion are started. The aircraft is getting off the ground and flying in a specified direction at the same time. The specified direction is adjusted with the help of the bypass valves (not shown in the drawings).

Having gained altitude in case of the aircraft lateral motion (motion in the horizontal plane), the blades 1, 2 of the upper turbine, blades 3, 4 of the lower turbine and side blades 5 may be shut (lowered) to starting position. In case of moving horizontally with descent the blades 1, 2 of the upper turbine, blades 3, 4 of the lower turbine and side blades 5 are open so that the headwind blowing from the bottom and in the direction of the aircraft motion rotates the turbines, creates resistance for the aircraft descent and generates electric power.

To maintain the required altitude, the upper turbine sucks the air from the top and directs it downwards keeping the aircraft at the required altitude. The lower turbine and the intermediate turbine (of intermediate turbines in case there are several of them) are involved when necessary; in this case, the turbines switch to the electric generators and generate electricity, which is supplied to the accumulators. The aircraft control center constantly monitors the operation of all turbines and their switching from one function to another (from the electric generators to the engines and vice versa), as well as the blades pitch (and/or extension) on each turbine is controlled.

The claimed aircraft is able to land in case of emergency even from high altitude, remaining undamaged as each turbine is provided with at least one air engine and separate receiver, which are separately connected to the compressor or several compressors. The air engines are automatically started at a certain speed of descent and maintain required speed when landing; the engines are provided with a separate (emergency) control system.

1. The vertical take-off and landing aircraft is characterized in that it comprises at least two turbines, the lower of which is dish-shaped and the upper is flat or dish-shaped, each turbine comprising a jet propulsion power unit, and the casing of each turbine is mounted on a metallic disk connected to a vertical shaft of the aircraft, and is equipped with blades mounted such that the position thereof can be changed.

2. The vertical take-off and landing aircraft as claimed in claim 1 is characterized in that it comprises at least one intermediate turbine mounted between the upper and lower turbines and made flat or dish-shaped.

3. The vertical take-off and landing aircraft as claimed in claim 1 is characterized in that it is equipped with a cockpit.

4. The vertical take-off and landing aircraft as claimed in claim 1 is characterized in that the jet propulsion power unit of each turbine comprises at least one air engine and receivers connected to a compressor or compressors.

5. The vertical take-off and landing aircraft as claimed in claim 1 is characterized in that to provide lateral-direction motion, the aircraft is equipped with at least one turbine for horizontal motion and air intakes connected to the bypass control valves by means of the internal turbine receivers.

6. The vertical take-off and landing aircraft as claimed in claim 1 is characterized in that the casing of each turbine is metallic and comprises at least two rings, one of which is connected to the disk, and also radial struts mounted along the perimeter of the turbine casing and connected to the rings and blades.

7. The vertical take-off and landing aircraft as claimed in claim 1 is characterized in that to change the position of the blades, the aircraft is equipped with a blade pitch control device and/or blade extension control device.

8. The vertical take-off and landing aircraft as claimed in claim 1 is characterized in that the blades are mounted at least in one row along the perimeter of the casing.

9. The vertical take-off and landing aircraft as claimed in claim 1 is characterized in that the blades are positioned at least in one tier.

10. The vertical take-off and landing aircraft as claimed in claim 1 is characterized in that the blades are mounted with partial overlapping.

11. The vertical take-off and landing aircraft as claimed in claim 1 is characterized in that it comprises additional side blades mounted on the casing of the turbines and configured to change the rotation angle by up to 90°.

12. The vertical take-off and landing aircraft as claimed in claim 1 is characterized in that it comprises electric generators.

13. The vertical take-off and landing aircraft as claimed in claim 1 is characterized in that to provide for the flat attitude in the air the aircraft is equipped with a balancing wing mounted on the casing of the upper turbine configured to adjust its rotation.

14. The vertical take-off and landing aircraft as claimed in claim 1 is characterized in that is equipped with supports for the purpose of the aircraft landing and parking.
